(19) United States
(12) Patent Application Publication
(10) Pub. No.: US 2022/0214268 A1
(43) Pub. Date: Jul. 7, 2022

(54) DIRECT MEASUREMENT METHOD OF QUANTUM RELAXATION TIME OF ELECTRONS AND TRANSPORT PROPERTIES OF PHOTO-INDUCED CARRIERS IN VARIOUS MATERIALS

(71) Applicant: Ningbo Galaxy Materials Technology Co. Ltd., Ningbo (CN)

(72) Inventors: Xiaodong Xiang, Ningbo (CN); Hongjie Guo, Ningbo (CN)

(73) Assignee: Ningbo Galaxy Materials Technology Co. Ltd., Ningbo (CN)

(21) Appl. No.: 17/505,597

(22) Filed: Oct. 19, 2021

Related U.S. Application Data
(60) Provisional application No. 63/094,157, filed on Oct. 20, 2020.

(51) Int. Cl. G01N 21/21; G01N 27/04

(52) U.S. Cl. CPC G01N 21/211; G01N 2021/213; G01N 27/04

(57) ABSTRACT

Methods for direct measurements of quantum relaxation time of electrons in a metal or conducting semiconductor, and of electron scattering rate of photo-induced carriers and other transport properties in intrinsic wide-bandgap semiconductors, through optical measurements. The measurement includes measuring complex dielectric function and calculating the imaginary part of the complex dielectric loss function

$$- Im ( \frac{1}{ɛ ( ω )} ) .$$

The

$$- Im ( \frac{1}{ɛ ( ω )} )$$

curve is analyzed to identify resonance peaks, and the peak position, peak height, and peak width are used to determine the screened plasma frequency ωₛ, background dielectric polarizability E_{c}(G0ₛ), and equivalent optical quantum relaxation time τ₀ (ωₛ) or equivalent optical electron scattering rate γ₀(ωₛ), respectively. Curve-fitting of the

$$- Im ( \frac{1}{ɛ ( ω )} )$$

curve is performed based on an asymmetry of the peak in the vicinity of ωₛ, to ultimately obtain the quantum relaxation time or electron scattering rate, including both the DC term and the AC term at ωₛ.

### BACKGROUND OF THE INVENTION

### Field of the Invention

This invention relates to materials characterization, and in particular, it relates to direct measurement of quantum relaxation time of electrons and transport properties of photo-induced carriers in various materials.

### Description of Related Art

### Quantum Relaxation Time of Electrons

Quantum relaxation time (τ) is one of the important physical properties affecting some most critical electron transport parameters in the advance materials, such as the electrical conductivity and carrier mobility in metals and semiconductors, the pseudo-gap and critical temperature of superconductors, and the propagation distance of an electron carrying encoded information in quantum computation materials and devices. It also relates to the weak localization effect of topological materials and the coupling of multi-degrees of freedom in strongly correlated systems. In optical-driven electronic devices, τ under an electromagnetic (EM) field is a critical factor in determining the information exchange between electrons and photons.

By far, the measurement of τ has never been a straightforward task. Conventionally, τ can only be determined indirectly under a static field by the equation: τ=μm*/e. While the carrier mobility (μ) is identified by the joint measurements of DC conductivity and Hall effect using electrical-contact methods, the effective mass (m*) is obtained by the magnetic oscillations experiment under ultra-high magnetic field and ultra-low temperature. A method for direct measurement of quantum relaxation time is a constant pursuit for physicists, especially at non-zero frequencies.

In 1900, Drude proposed a theory describing the interaction between photon and conduction electron, which paves the way to an optical solution for quantum relaxation time measurement. Drude model predicts the resonance of conducting electrons in a material under an optical radiation at plasma frequency ωₚ. Drude model was later modified with Quantum Theory by Sommerfeld and others, resulting in a universal expression of Drude-Sommerfeld complex dielectric function for all conductive materials, i.e., the response of a free electron gas to an optical radiation derived from Maxwell Equation:

$$\begin{matrix}{ɛ}^{D} ( ω ) = {ɛ}_{r}^{D} + i {ɛ}_{i}^{D} = ( {ɛ}_{c} - \frac{{ω}_{p}^{2}}{{ω}^{2} + 1 / {τ}_{D}^{2}} ) + i \frac{{ω}_{p}^{2}}{{ωτ}_{D} ( {ω}^{2} + 1 / {τ}_{D}^{2} )} , & ( A1 ) \\ where , {ω}_{p}^{2} = \frac{4 π {n}_{e} {e}^{2}}{{m}^{*}} , & ( A2 )\end{matrix}$$

and τ_{D}, is the Drude quantum relaxation time (reciprocal of the electron scattering rate), which is considered frequency independent and thus can be determined under DC field; ϵ_{c} the background dielectric polarizability equals to unity in the original model; ηₑ the number of conduction electrons (around the Fermi surface) per unit volume; m* the effective mass of conduction electrons.

Via introducing the effective mass, the background lattice effect to the conduction electrons is partly accounted for in Equation (A1) and (A2) and the plasma frequency is rewritten with a redefinition of electron mass by band structure effective mass of quasi-particle. Subsequently, the single quantum relaxation time of all conduction electrons hypothesized by Drude is naturally explained by single Fermi energy per Fermi-Dirac statistics for all conductive electrons. This has been proven valid even for highly correlated heavy-fermion system.

In some more recent works, a constant ϵ_{c}=1+4πnα is introduced to resolve the discrepancies between the model and experimental values of plasma frequency, where α, a constant, is the ionic polarizability coefficient, and n is the atomic density. As a result, the resonance is expected to occur where ϵ_{τ}(ω) vanishes at the so-called screened plasma frequency ωₛ instead of ωₚ to account for the frequency shift due to screening of conduction electrons, where:

$${ω}_{s}^{2} = \frac{{ω}_{p}^{2}}{{ɛ}_{c}} = 1 / {τ}_{D}^{2} . \qquad ( A3 )$$

Here the background dielectric polarizability ϵ_{c} for different materials is obtained by fitting the plot of ϵ_{τ}^{D} vs 1/ω² over wide range frequencies with the assumption ω>>1/τ_{D}:

$${ɛ}_{r}^{D} = ( ω ) \approx {ɛ}_{c} - \frac{{ω}_{p}^{2}}{{ω}^{2}} . \qquad ( A3 )$$

The slope and intercept of the plot correspond to ωₚ² and ϵ_{c}, respectively.

However, problems remain. First, a constant value of ω_{c}>1 is not physical, since when ω→∞, ϵ_{c} should equal to unity from both experimental and theoretical point of view. Secondly, since fitting with experimental data in different frequency ranges yields varied slopes with 1/ω², the resulting ω_{c} cannot be uniquely determined (differing by several times). As shown in FIG. 1A, the fits of Ag based on Equation (A4) in different wavelength range would give varied fitting results. Moreover, the screened plasma wavelengths do not match the experimentally determined

resonance frequencies. For Ag and Au,

$${λ}_{s} = \frac{2 π c}{{ω}_{s}}$$

are calculated to be 267 and 329 nm based on Equations (A3 and A4) using reported data, which are 21-47% smaller than the observed resonance frequencies of 323 and 485 nm, respectively. Notably, the deviations of fitting greatly increase in the alkali metals (Cs), as shown in FIG. 1B. In FIGS. 1A and 1B, the fitting processes for Ag is in the range from 210 nm to 1305 nm (“Fitting 2”, blue curve in (A)) and from 1350 nm to 2480 nm (“Fitting 1”, orange curve in (A)); for Cs it is in the range from 310 nm to 1050 nm (“Fitting 2”, blue curve in (B)) and from 1100 nm to 2200 nm (“Fitting 1”, orange curve in (B)), respectively. The relaxation time τ_{D}, can also be deduced by applying the same assumption to the imaginary part of Equation (A1) as:

$${ɛ}_{i}^{D} ( ω ) \cdot ω \approx \frac{{ω}_{p}^{2}}{{ω}^{2}} \cdot \frac{1}{{τ}_{D}} \qquad ( A5 )$$

Theye obtained the quantum relaxation time of Au films from Equation (A5) using dielectric constant data over wide frequency range, and found that 1/τ_{D} is, to certain extend, frequency dependent. Nagel & Schnatterly proposed a two-carrier model emphasizing the contribution from conductions electrons scattering and disordering in grain boundaries. However, the reciprocal relaxation time due to the disorder effect only increases slightly (less than 10%) with frequency for annealed samples, far from being sufficient to account for the experimentally observed fivefold increase in 1/τ_{D} at plasma resonance.

### Wide-Bandgap Semiconductors (WBGSs)

Semiconductor materials construct the edifice of modern electronic devices, including transistors, solar cells, diodes, integrated circuits, and quantum devices. Compared to conventional semiconductors, (e.g. silicon and GaAs), wide-bandgap semiconductors (WBGSs), such as SiC and GaN, have a relatively large band gap in the range above 2 eV. This makes WBGSs having many advantages such as bearing higher operating temperatures, working voltages, and response frequencies. These features should have tremendous application potential in the next-generation electronic devices, especially in the field of millimeter wave wireless network and long-coherent-time system of quantum computation.

However, the difficulty is constructing p-n junctions of WBGSs. Unlike in the case of conventional semiconductors, some types of WBGSs, e.g., n-type diamond and p-type ZnO, are very difficult to fabricate. This is due to limited solubility of dopants, high active energy or self-compensation. Much effort has been paid to solve these problem, including the codoping method, the cluster-doping approach and the built-in electronic polarization technique, without satisfactory results. For instance, effective doping of p-type GaN takes years to be realized, while the hole concentration remains less than 10¹⁸ cm⁻³. Furthermore, even if the doping could be realized, it introduces the significant impurities and defects. This would greatly lower down the mobility (e.g., from hundreds to several cm²/V·s with increasing Mg-doping concentration in GaN), due to the ionized impurities scattering and alloy disorder scattering. These problems hinder the study and application of WBGSs in the high-performance devices, such as the high-frequency field-effect transistors.

It is well known that photons with energy above the bandgap of semiconductors can induce carriers in the intrinsic semiconductors. In addition, Drude model describes the photon-electron interaction and reveals the characteristics of conducting electrons at Fermi level.

### SUMMARY

A first embodiment of the present invention provides a method that can directly determine quantum relaxation time at zero and non-zero frequencies using optical measurement. Through dielectric loss function, connect bound electron effect is connected to the physical parameters of plasma resonance and an extra term of quantum relaxation time due to inelastic scattering between bound electrons and conduction electrons at non-zero frequencies is found. The inventors demonstrates that the frequency dependent inelastic polarization effect of bound electrons is the dominating contribution on quantum relaxation time of conduction electrons at optical frequencies and elastic polarization effect of bound electrons also dramatically changes the plasma resonance frequency through effective screening to charge carriers.

A second embodiment of the present invention provides an optical method to characterize the transport properties of the conduction bands for intrinsic wide-bandgap semiconductors through study of photo-induced carrier plasma resonance. This method paves a potential path in future development of advanced electronic and quantum devices of wide-band semiconductors.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a method for direct measurement of quantum relaxation time of electrons in a material sample, which includes: measuring optical data of the sample to obtain an imaginary part of a dielectric loss function as a function of frequency ω,

$$- Im ( \frac{1}{ɛ ( ω )} ) ;$$

and analyzing the imaginary part of the dielectric loss function to obtain a frequency-independent quantum relaxation time τ_{D} of the sample and a frequency-dependent quantum relaxation time of the sample at a screened plasma frequency ωₛ, τ_{AC}(ωₛ).

In preferred embodiments, the measuring step includes: using a spectroscopic ellipsometer, measuring spectra of ellipsometric angles ψ (amplitude ratio) and Δ (phase shift difference) of the sample; and calculating a complex dielectric function ϵ((ω) of the sample from the measured ellipsometric angles ψ and Δ, and calculating the complex dielectric loss function of the sample as an inverse of the complex dielectric function.

In preferred embodiments, the analyzing step includes: identifying a peak in the imaginary part of the dielectric loss function; and obtaining the screened plasma frequency ωₛ, a background dielectric polarizability at the screened plasma frequency ϵ_{c}(ωₛ), and an equivalent optical quantum relaxation time at the screened plasma frequency τ₀ (ωₛ) from a peak position, a peak height, and a peak width of the peak, respectively, where the peak position equals the screened plasma frequency ωₛ, the peak height equals

$$\frac{{ω}_{s}}{{ɛ}_{c} ( {ω}_{s} )} {τ}_{o} ( {ω}_{s} ) ,$$

and a full width at half maximum of the peak equals 1/τₒ (ωₛ).

In preferred embodiments, the analyzing step further includes: curve-fitting the imaginary part of the dielectric loss function based on an asymmetry of the peak using an equation:

$$- Im ( \frac{1}{ɛ ( ω )} ) = \frac{\frac{{ω}_{p}^{2}}{{ωτ}_{D} ( {ω}^{2} + {τ}_{D}^{- 2} )} + {ɛ}_{i}^{B} ( ω )}{{( 1 - \frac{{ω}_{p}^{2}}{{ω}^{2} + {τ}_{D}^{- 2}} + {ɛ}_{T}^{B} ( ω ) )}^{2} + {( \frac{{ω}_{p}^{2}}{{ωτ}_{D} ( {ω}^{2} + {τ}_{D}^{- 2} )} + {ɛ}_{i}^{B} ( ω ) )}^{2}} ,$$

to obtain ϵᵢ^{B} (ω) in a vicinity of the screened plasma frequency, where coₚ is a plasma frequency, and ϵᵣ^{B (ω) and ϵ}ᵢ^{B} (ω) are a real part and an imaginary part, respectively, of a bound electron term ϵ^{B} (ω) of the complex dielectric function which represents elastic and inelastic deformation of bound electron polarization effect; calculating τ_{D} based on ϵᵢ^{B} (ω), using equation:

$$- Im \{ \frac{1}{ɛ ( {ω}_{s} )} \} = \frac{1}{{ɛ}_{i} ( {ω}_{s} )} = \frac{{ω}_{s} / {ɛ}_{c} ( {ω}_{s} )}{1 / {τ}_{D} + {ɛ}_{i}^{B} ( {ω}_{s} ) / {ɛ}_{c} ( {ω}_{s} )} ;$$

calculating τ_{AC} (ωₛ) based on ϵᵢ^{B} (ω), using equation:

1/τ_{AC}(ωₛ)=ϵᵢ^{B}(ωₛ)ωₛ/ϵ_{c}(ωₛ);

and calculating ωₚ based on ϵ_{c}(ωₛ) and τ_{D}, using an equation which represents a resonance frequency shift:

$${ω}_{s}^{2} = \frac{{ω}_{p}^{2}}{{ɛ}_{c} ( {ω}_{s} )} - 1 / {τ}_{D}^{2} .$$

In some embodiments, in the curve-fitting step, ϵᵢ^{B} (ω) is approximated as either a constant or a linear function within the vicinity of the screened plasma frequency.

In some embodiments, the sample is a metal material. In some embodiments, the sample is a conducting semiconductor.

In some embodiments, the quantum relaxation time is temperature dependent, wherein the measuring step includes: controlling a temperature of the sample using a heat stage; and measuring the optical data of the sample at a plurality of temperatures, and wherein the analyzing step is performed for the optical data measured at each of the plurality of temperatures.

In another aspect, the present invention provides a method for direct measurement of transport properties of photo-induced carriers in a material sample, which includes: irradiating the sample with a coherent or incoherent light to elevate all valence electrons into free electrons; while irradiating the sample, measuring optical data of the sample to obtain an imaginary part of a dielectric loss function as a function of frequency ω,

$$- Im ( \frac{1}{ɛ ( ω )} ) ;$$

and analyzing the imaginary part of the dielectric loss function to obtain a frequency-independent DC electron scattering rate γ_{D} and a frequency-dependent electron scattering rate at a screened plasma frequency ωₛ, γ_{AC}(ωₛ)

In preferred embodiments, the measuring step includes: using a spectroscopic ellipsometer, measuring spectra of ellipsometric angles ψ (amplitude ratio) and Δ (phase shift difference) of the sample; and calculating a complex dielectric function ϵ (ω) of the sample from the measured ellipsometric angles ψ and Δ, and calculating the complex dielectric loss function of the sample as an inverse of the complex dielectric function.

In preferred embodiments, the analyzing step includes: identifying a peak of the imaginary part of the dielectric loss function; and obtaining the screened plasma frequency ωₛ, a background dielectric polarizability at the screened plasma frequency ϵ_{c}(ωₛ), and an equivalent optical electron scattering rate at the screened plasma frequency γₒ (ωₛ) from a peak position, a peak height, and a peak width of the peak, respectively, wherein the peak position equals the screened plasma frequency ωₛ, the peak height equals

$$\frac{{ω}_{s}}{{ɛ}_{c} ( {ω}_{s} ) {γ}_{o} ( {ω}_{s} )} ,$$

and a full width at half maximum of the peak equals γₒ (ωₛ).

In preferred embodiments, the analyzing step further includes: curve-fitting the imaginary part of the dielectric loss function based on an asymmetry of the peak, using an equation:

$$- Im ( \frac{1}{ɛ ( ω )} ) = \frac{\frac{{ω}_{p}^{2} {γ}_{D}}{ω ( {ω}^{2} + {γ}_{D}^{2} )} + {ɛ}_{i}^{B} ( ω )}{{( {ɛ}_{c} ( ω ) - \frac{{ω}_{p}^{2}}{{ω}^{2} + {γ}_{D}^{2}} )}^{2} + {( \frac{{ω}_{p}^{2} {γ}_{D}}{ω ( {ω}^{2} + {γ}_{D}^{2} )} + {ɛ}_{i}^{B} ( ω ) )}^{2}}$$

to obtain ϵᵢ^{B} (ω) in a vicinity of the screened plasma frequency, where ωₚ is a plasma frequency, ϵ_{c}(ω)=1+ϵᵣ^{B}(ω), and ϵᵣ^{B (ω) and ϵ}ᵢ^{B} (ω) are a real part and an imaginary part, respectively, of a bound electron term ϵ^{B} (ω) of the complex dielectric function which represents elastic and inelastic deformation of bound electron polarization effect; calculating γ_{D} based on ϵᵢ^{B} (ω), using equation:

$$- Im \{ \frac{1}{ɛ ( {ω}_{s} )} = \frac{1}{{ɛ}_{i} ( {ω}_{s} )} = \frac{{ω}_{s} / {ɛ}_{c} ( {ω}_{s} )}{{γ}_{D} + {ɛ}_{i}^{B} ( {ω}_{s} ) {ω}_{s} / {ɛ}_{c} ( {ω}_{s} )} = \frac{{ω}_{s}}{{ɛ}_{c} ( {ω}_{s} ) {γ}_{o} ( {ω}_{s} )} ;$$

calculating γ_{AC} (ωₛ) based on ϵᵢ^{B} (ω), using equation:

γ_{AC}(ωₛ)=ϵᵢ^{B} (ωₛ)ωₛ/ϵ_{c};

and calculating ωₚ based on ϵ_{c} (ωₛ) and γ_{D}, using an equation which represents a resonance frequency shift:

$${ω}_{s} = {( {ω}_{p}^{2} / {ɛ}_{c} ( {ω}_{s} ) - {γ}_{D}^{2} )}^{1 / 2} .$$

In preferred embodiments, in the curve-fitting step, ϵᵢ^{B} (ω) is approximated as either a constant or a linear function within the vicinity of the screened plasma frequency.

In some embodiments, the sample is an intrinsic wide-bandgap semiconductor material, wherein the analyzing step further includes identifying multiple peaks in the imaginary part of the dielectric loss function, and wherein the obtaining step and the curve-fitting step are performed for each of the plurality of identified peaks.

In some embodiments, the method further includes: calculating a resistivity of the sample P_{D}=γ_{D}/ϵ₀ωₚ²; and calculating a mobility at DC field of the sample as μ_{D}=e/γ_{D}M*, where m* is an effective mass of the electrons.

It is to be understood that both the foregoing general description and the following detailed description are exemplary and explanatory and are intended to provide further explanation of the invention as claimed.

### BRIEF DESCRIPTION OF THE DRAWINGS

FIGS. 1A and 1B show fitting of experimental data according to conventional models of the dielectric function, showing the fits of (A) Ag and (B) Cs in different ranges: the experimental data (black square) and fitting results based on Equation (A4).

FIG. 2A shows a comparison of experimental and calculated values of n(cω), k(ω) for aluminum: experimental data (black solid line), Drude results based on Equation (1) (blue dash line) and Drude model modified with a square -frequency dependence of reciprocal relaxation time (pink dotted line).

FIG. 2B shows a comparison of experimental data (black solid line) and Drude model (parameters in Table 1) combined with DFT calculations (green dash dotted line).

FIG. 3 shows the imaginary part of Drude (black line, peak on the left) and complete (blue line, peak on the right) dielectric loss function of Al with parameters of ϵ_{c}=0.78, ωₚ/(2πc)=106873 cm⁻¹, ϵ^{B}(ωₛ)=−0.22+i 0.028. The blue squares are experimental values, while the black dots are the corresponding Drude-only results based on the analysis of ϵ^{D}(ω)=ϵ(ω)−ϵ^{B}(ω).

FIGS. 4A-4F show fittings of imaginary part of dielectric loss function based on the optical data of (A) potassium, (B) rubidium, (C) silver, (D) gold, (E) cesium and (F) nickel. The corresponding fitted parameters are shown in Table 1.

FIG. 5 shows the imaginary parts of dielectric function of Rb and Cs.

FIG. 6A shows a DLF-BE analysis of ITO at 303 K.

FIG. 6B shows a comparison of resistivity ρ_{D} (T) from optical method and four-point probe method.

FIG. 7A shows Table 1, Drude's parameters of different metals obtained from various methods.

FIG. 7B shows Table 2, fitting parameters of ITO obtained at different temperatures.

FIG. 8A shows the real (black solid line) and (black dotted line) imaginary parts of in-plane dielectric function of graphite and corresponding imaginary part of dielectric loss function (blue solid line).

FIGS. 8B and 8C show the separated DC term of the resonant dielectric loss peak (black squares) and Drude fittings (blue solid line) corresponding to π electrons and π+σ electrons, respectively.

FIG. 9A shows the experimental ϵ(ω) and −Imϵ(ω)⁻¹ of diamond.

FIG. 9B shows the separated DC term−Im(1/ϵ)_{D} of diamond. The blue dots and black squares represent experimental data, while the blue solid line represent fitting values.

FIG. 10A shows the experimental ϵ(ω) and Imϵ(ω)⁻¹ of SiC.

FIG. 10B shows the separated DC termIm(1/ϵ)_{D} of SiC. The blue dots and black squares represent experimental data, while the blue solid line represent fitting values.

FIG. 11A shows the experimental ϵ(ω) and I ME (CO)⁻¹ of B₄C.

FIG. 11B shows the separated DC term−Im(1/ϵ)_{D} of B₄C. The blue dots and black squares represent experimental data, while the blue solid line represent fitting values.

FIG. 12 shows Table 3, the fitting parameters of fitting the DC term by the Drude model.

FIG. 13 schematically illustrates a method of direct measurement of quantum relaxation time of electrons in a material according to a first embodiment of the present invention.

FIG. 14 schematically illustrates a method of direct measurement of transport properties of photo-induced carriers in a material according to a second embodiment of the present invention.

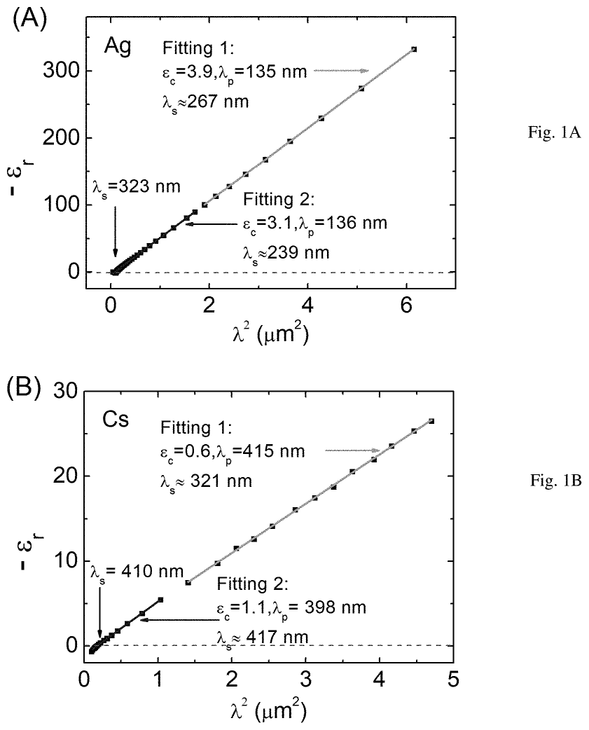

### DETAILED DESCRIPTION OF PREFERRED EMBODIMENTS

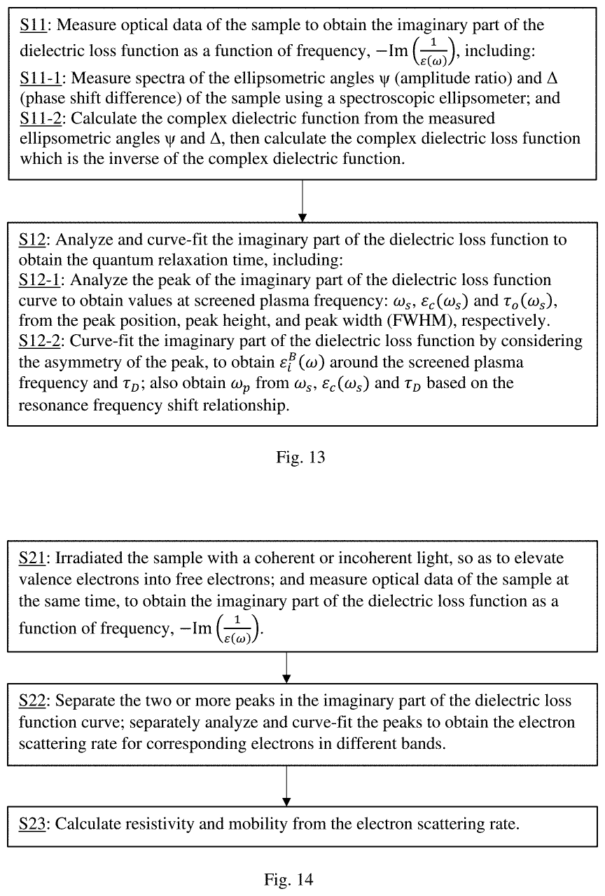

The principles of direct measurements of the quantum relaxation time of electrons and transport properties of photo-induced carriers in various materials are described first. The measurement methods are then summarized with reference to FIGS. 13 and 14.

### Quantum Relaxation Time

As shown in above examples, there exists a large deficiency for Drude-Sommerfeld model to explain the experimental data. The dielectric function is the consequence of the primary effect from the interaction between EM field and free electrons correctly described by the Drude model, which characterized by the bare plasma frequency ωₚ and the frequency-independent quantum relaxation time τ_{D}; it is also the consequence of the primary effect from the interaction between EM field and bound electrons, due to the excitations or transitions from valence band to conduction band. The inventors believe that a secondary effect, results from the interaction between conducting electron oscillation and bound electron oscillation, can account for the large deficiency between the description of Drude model and optical data.

Therefore, the bound electron effect must be included in the model analysis. With this in mind, the total complex dielectric function should be written as:

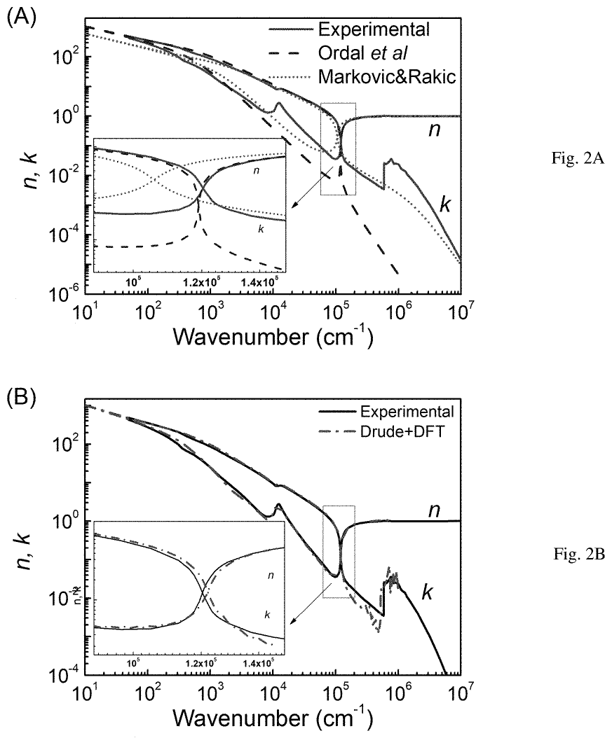

ϵ(ω)=ϵ^{D}(ω)+ϵ^{B}(ω) (A6)

where ϵ^{B} (ω)=EB (co) +i.ϵᵢ^{B} (ω) describes the elastic and inelastic deformation of bound electron polarization effect and can be calculated according to the Fermi's golden rule through the density functional theory. Lorentz simple harmonic oscillator model was used to approximate ϵ^{B} (ω), but the success is limited. In another attempt, Markovic & Rakic proposed to consider a frequency-dependent “electron re-radiation” effect into the Drude-Sommerfeld model, which is related to the response to EM wave from both conduction electrons as well as bound electrons, and causing a change of phase speed of EM radiation. By replacing 1/T_{D} with 1/t(ω)=1/T_{D} +bω², the complex refractive index [n(ω) and k(ω)] of Al is fitted as shown in FIG. 2A.

Not only the fitted plasma frequency (˜94 nm) deviates from the experimental data (83 nm) more than that obtained from the simple Drude-Sommerfeld model, but the reciprocal relaxation time (1590 cm⁻¹) at plasma resonance frequency is also three times of the DC value of ˜550 cm⁻¹ (from DC resistivity and ωₚ by

$$\frac{1}{{τ}_{D}} = \frac{{ω}_{p}^{2}}{4 π} {ρ}_{dc} ) ,$$

dramatically deviates from experimental results.

It came to the inventors' realization that ϵ^{B} (ω) is a very complex and sample-dependent term that requires a more complex function of superposition of multiple harmonic oscillators. In FIG. 2B, the n(ω) and k(ω) of A1 is calculated based on Equation (A6) with ϵ^{B} (ω) obtained by density functional theory (DFT), which takes into account all possible band transitions and appropriate quantum statistics. Comparing with the data in FIG. 2A, a significant improvement is achieved with a more suitable bound electron term on the dielectric function. This proves that for the model to match with the optical data, a complex form has to be used to describe the bound electrons effect with sufficient details.

The first embodiment of the present invention and its variations provide a new measuring method by accounting for both contributions of conduction (Drude term) and bound electrons to determine frequency-dependent quantum relaxation times. The complex bound electron effects were analyzed with experimental data through multi-parameters fitting of dielectric loss function. All the results clearly prove that the effect of bound electrons plays a dominant role in quantum relaxation at optical frequencies.

To understand the impact of the bound electron term ϵ^{B} (ω) on the damping effect to conduction electrons at plasma resonance, an approach used for electron scattering loss analysis is adopted. First, the dielectric loss function (DLF, defined as the inverse of the dielectric function) is utilized:

$$\frac{1}{ɛ ( ω )} = \frac{{ɛ}_{r} ( ω ) - i {ɛ}_{i} ( ω )}{{ɛ}_{r}^{2} ( ω ) + {ɛ}_{i}^{2} ( ω )} \qquad ( A7 )$$

If only the interaction with free electrons ϵ^{D} (ω) is considered, the real and imaginary parts of dielectric loss function

$$\frac{1}{ɛ ( ω )}$$

are given by Dressel and Gruner as

$$Re {\{ \frac{1}{ɛ ( ω )} \}}_{D} = 1 + \frac{( {ω}^{2} - {ω}_{p}^{2} ) {ω}_{p}^{2}}{{( {ω}^{2} - {ω}_{p}^{2} )}^{2} + {ω}^{2} {τ}_{D}^{- 2}} , \\ and - Im {\{ \frac{1}{ɛ ( ω )} \}}_{D} = 1 + \frac{( {ω}^{2} - {ω}_{p}^{2} ) {ω}_{p}^{2}}{{( {ω}^{2} - {ω}_{p}^{2} )}^{2} + {ω}^{2} {τ}_{D}^{- 2}} , \qquad ( A8 )$$

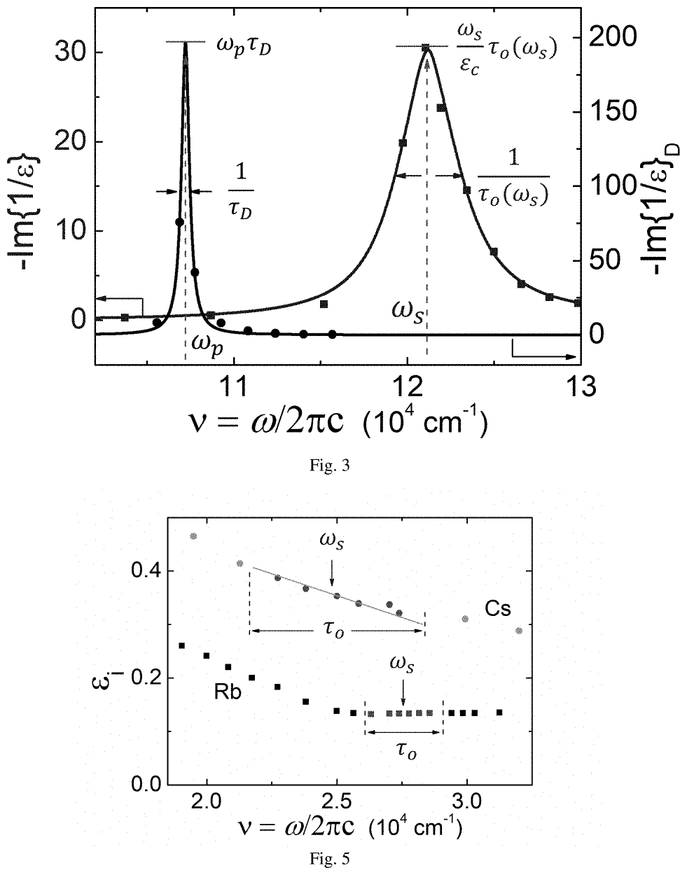

respectively. As shown in FIG. 3, the Drude term

$$Im {\{ \frac{1}{ɛ ( w )} \}}_{D}$$

has a very sharp symmetric plasma resonance peak at ωₚ with a maxima of ωₚτ_{D}, and full width at half maximum (FWHM) of 1/T_{D}. Considering the secondary scattering effect between conducting and bound electrons, the bound electron effect described by ϵ^{B} is included into the dielectric loss function. The resonance frequency shifts from ωₚ to the screened plasma frequency ωₛ, given by:

$$\begin{matrix}{ω}_{s}^{2} = \frac{{ω}_{p}^{2}}{{ɛ}_{c} ( {ω}_{s} )} = 1 / {τ}_{D}^{2} , & ( A9 ) \\ {ɛ}_{c} ( {ω}_{s} ) = 1 + {ɛ}_{r}^{D} ( {ω}_{s} ) . & ( A10 )\end{matrix}$$

Here ϵ_{c}(ωₛ) is not an arbitrary number, but a measurable and calculable physical quantity that approaches to 1 as ω→∞. Since ωₛ depends on carrier density ηₑ, in principle it can be controlled to be any frequency, especially through impurity or optical doping levels in semiconducting materials. Therefore Equation (A10) is valid for any frequency.

Taking ϵᵣ(ω)=ϵᵣ^{D}(ω)+ϵᵣ^{B}(ω) and ϵᵢ(ω)=ϵᵢ^{D}(ω)+ϵᵢ^{B} (ω) into Equation (A7) yields _{<CWU}-_{Call number} =“ ₄₅ ” /_{>}

$$Re \{ \frac{1}{ɛ ( ω )} \} = \frac{1 - \frac{{ω}_{p}^{2}}{{ω}^{2} + {τ}_{D}^{- 2}} + {ɛ}_{T}^{B} ( ω )}{{( 1 - \frac{{ω}_{p}^{2}}{{ω}^{2} + {τ}_{D}^{- 2}} + {ɛ}_{T}^{B} ( ω ) )}^{2} + {( \frac{{ω}_{p}^{2}}{{ωτ}_{D} ( {ω}^{2} + {τ}_{D}^{- 2} )} + {ɛ}_{i}^{B} ( ω ) )}^{2}} , \\ and - Im \{ \frac{1}{ɛ ( ω )} \} = \frac{\frac{{ω}_{p}^{2}}{{ωτ}_{D} ( {ω}^{2} + {τ}_{D}^{- 2} )} + {ɛ}_{T}^{B} ( ω )}{{( 1 - \frac{{ω}_{p}^{2}}{{ω}^{2} + {τ}_{D}^{- 2}} + {ɛ}_{T}^{B} ( ω ) )}^{2} + {( \frac{{ω}_{p}^{2}}{{ωτ}_{D} ( {ω}^{2} + {τ}_{D}^{- 2} )} + {ɛ}_{i}^{B} ( ω ) )}^{2}} , \qquad ( A11 )$$

Using ϵᵣ(ωₛ)=0 in Equation (A11), the peak value of dielectric loss spectrum at ωₛ can be deduced:

$$- Im \{ \frac{1}{ɛ ( {ω}_{s} )} \} = \frac{1}{{ɛ}_{i} ( {ω}_{s} )} = \frac{{ω}_{s} / {ɛ}_{c} ( {ω}_{s} )}{1 / {τ}_{D} + {ɛ}_{i}^{B} ( {ω}_{s} ) {ω}_{s} / {ɛ}_{c} ( {ω}_{s} )} . \qquad ( A12 )$$

### Let Equation (A12) be

$$\frac{{ω}_{s}}{{ɛ}_{c} ( {ω}_{s} )} {τ}_{o} ( {ω}_{s} ) ,$$

an equivalent optical quantum relaxation time τₒ (ω) and the corresponding FWHM of this new resonance can be obtained:

1/τ₀(ωₛ)=1/96 _{D}+1/τ_{AC}(ωₛ) (A13)

where the term 1/τ_{AC}(ωₛ)=ϵᵢ^{B}(ωₛ)ωₛ/ϵ_{C}(ωₛ) turns the sharp symmetric resonance peak into a broadened asymmetric resonance peak due to inelastic scattering of conduction electrons by bound electrons as shown in FIG. 3. Hence, the measurement of the FWHM of the dielectric loss peak can provide a direct means to identify the quantum relaxation time at a given non-zero frequency (i.e., the plasma frequency).

For a real material, ωₛ, ϵ_{c}(ωₛ), and τ₀ (ωₛ) can first be determined with the measured peak position, peak value and FWHM of plasma resonance, and then ϵᵢ^{B} (ω) and τ_{D} can be

determined by fitting the asymmetric function of

$$- Im \{ \frac{1}{ɛ ( ω )} \}$$

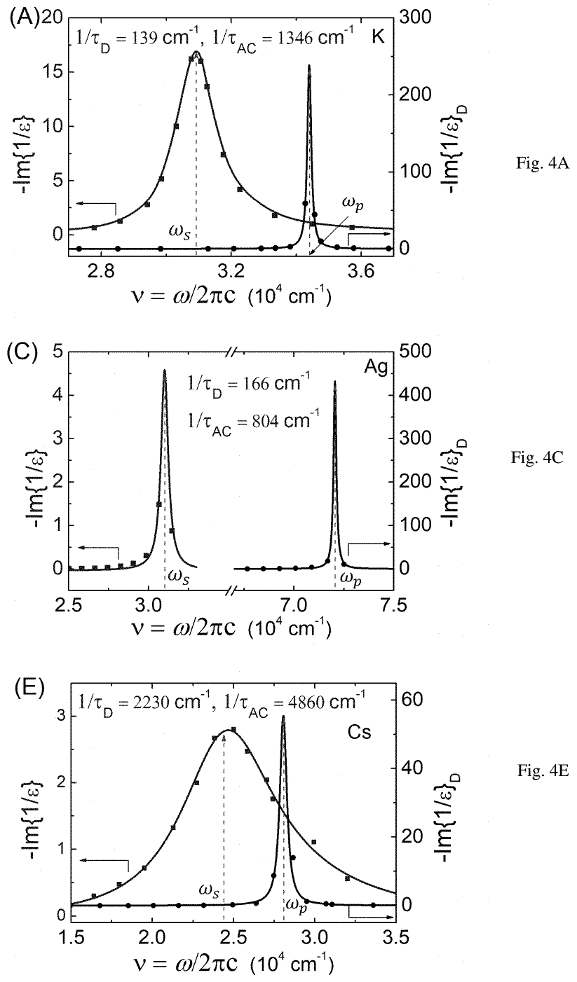

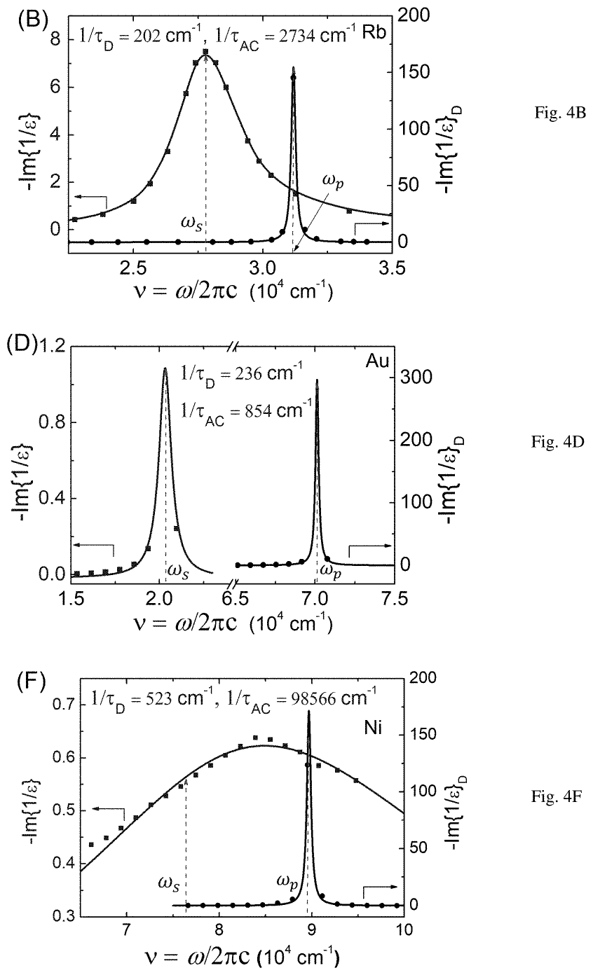

with optical data, and ωₚ can be determined based on Equation (A9). To manifest the Drude term clear, an axis transformation can be made to eliminate the contribution of bound electrons (black dot and line in FIGS. 3 and 4A-F), including two parts, i.e., the first is the screening of conduction carrier density, resulting in the change of plasma frequency; the second is the asymmetric broadening of plasma resonance peak. It is important to note that quantum relaxation time obtained by the method according to embodiments of the present invention is the only direct measurement to the inventors' knowledge. It is also important to note that in addition to phonon-electron, impurity-electron and electron-electron scattering, the inventors found an additional new scattering mechanism for the quantum relaxation time of conduction electrons in solids at non-zero frequencies for the first time.

DLF analysis with bond electron contributions (DLF-BE) was performed on metals K, Rb, Ag, Au, Cs and Ni and the imaginary parts

$$- Im \{ \frac{1}{ɛ ( ω )} \} and - Im {\{ \frac{1}{ɛ ( ω )} \}}_{D}$$

are plotted in FIGS. 4A-F. It is noted that the ωₛ of all 6 metals is red-shifted relative to ωₚ, opposite to the case of A1(FIG. 3) in which the shift is toward blue. This is attributed to the fact that the real part of dielectric function for bound electrons ϵᵣ^{B}(ωₛ) of A1is negative, while that of other 7 metals are positive. Within the narrow vicinity of plasma resonance, ϵᵢ ^{B} (ω) can be approximated as either a constant or a simple function, such as linear function, depending on the characteristics of the measured data. For example, as shown in FIG. 5, values of ϵᵢ^{B}(ω) of Rb hardly change within plasma resonance region, a constant value can therefore be assumed for the fitting purpose. The ϵᵢ^{B}, of Al, K, Ag, Au are also treated as constant around ωₛ. In contrast, the data for Cs follow a straight line, the data can thus be fitted with a linear function £B (w) =a +bw to yield a=0.56, b=1.28×10⁻⁵ cm, and the values of ϵᵢ^{B}(ωₛ)=0.25 and 1/(2πCτ_{D})=2230±100 cm⁻¹. If a constant ϵᵢ^{B}(ω) is used instead of a linear function for Cs, the fitting error of 1/(2πCτ_{D}) would increase significantly from less than 10% to 50%. For Ni, a linear and parabolic function Eᵢ^{B}(ω)=a+b·ω+c·ω²(α=15.75, b=-3.25×10⁻⁴ cm, c =1.86x10⁻⁹ cm²) is used for fitting the experimental data around plasma resonance. If a linear function ϵᵢ^{B}(ω) is utilized for Ni, the fitting results cannot be self-consistent.

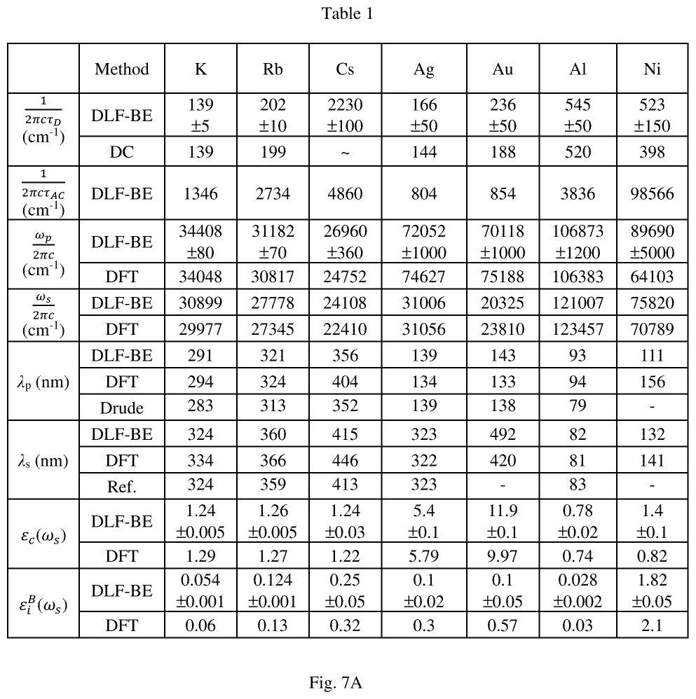

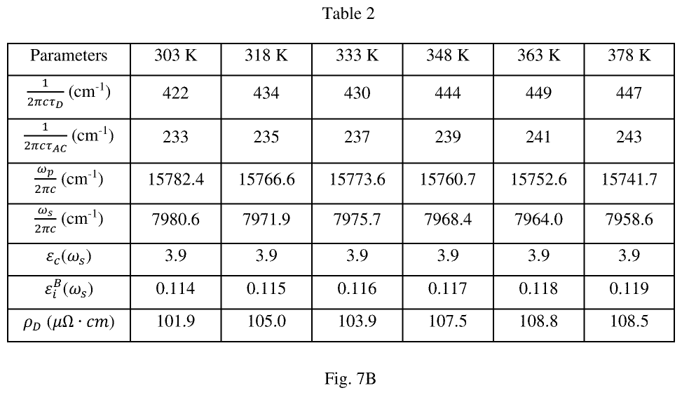

Table 1 (FIG. 7A) summarizes the parameters τ₀, ωₚ, ωₛ, ϵ_{c}(ωₛ), ϵᵢ^{B}(ωₛ) obtained by DLF-BE analysis and the zero-frequency relaxation time (τ_{D}) deduced from resistivity data for metals K, Rb, Ag, Au, Cs, Al and Ni. The comparative ωₚ and ϵᵢ^{B}(ω) results from DFT calculations using Vienna Ab initio Simulation Package and ϵᵣ^{B (ω) calculated from ϵ}ᵢ^{B} (ω) by Kramers-Kronig relations are also listed in Table 1. DLF-BE: Optical data processed with DLF analysis; DFT: modeled by DFT method; Drude: optical data fitted by Drude model; and DC: derived from

$$\frac{1}{{τ}_{D}} = \frac{{ω}_{p}^{2}}{4 π} {ρ}_{dc}$$

using resistivity data and DFT calculated ωₚ.

As shown in Table 1, the screened plasma wavelength λₛ values obtained by DLF-BE method agree perfectly with the experimental values. In the meantime, λₚ values from DLF-BE match well with the DFT calculations, in contrast to the previously reported discrepancies with Drude model. This confirms that the screening effect of bound electron is well represented by a proper expression obtained from DLF-BE analysis. The zero frequency relaxation time (C_{D}) from DLF-BE analysis is generally in good agreement with the result from DC electrical measurement at room temperature for all the metals. However for Cs, 1/τ_{D} obtained by DLF-BE analysis is significantly larger than the DC one, presumably due to the difference in the sample impurity levels of Cs. The DFT calculated ϵ_{c}(ωₛ) and ϵᵢ^{B} are also consistent with the parameters derived from experimental data. It was noted that for Alkali metals, while the elastic polarization effects are relatively small (ωₚ/ωₛ˜1.1-1.2), the inelastic polarization effects are very large, i.e., 1/⁻c_{iic} values are 10-15 times higher than 1/T_{D}. For transition metals Ag, Au and Ni the elastic polarization effects are much larger (2-4 times), while the inelastic polarization effects are moderately larger (˜4 times). In short, 1/τ_{AC} term contributes significantly more than 1/τ_{D} in τ₀(ωₛ) in all cases here. This suggests the bound electrons effect is a dominant contribution for electron quantum relaxation in UV-Visible optical frequency range and also induces large changes in plasma resonance frequencies. On the other hand, the results also indicate that the assumption of frequency-independent quantum relaxation time in Drude term suggested in the past cannot describe the optical response correctly. This is the first time that bound electron polarization effect to be used to determine conduction electron's quasi-particle effective properties—carrier density and quantum relaxation time.

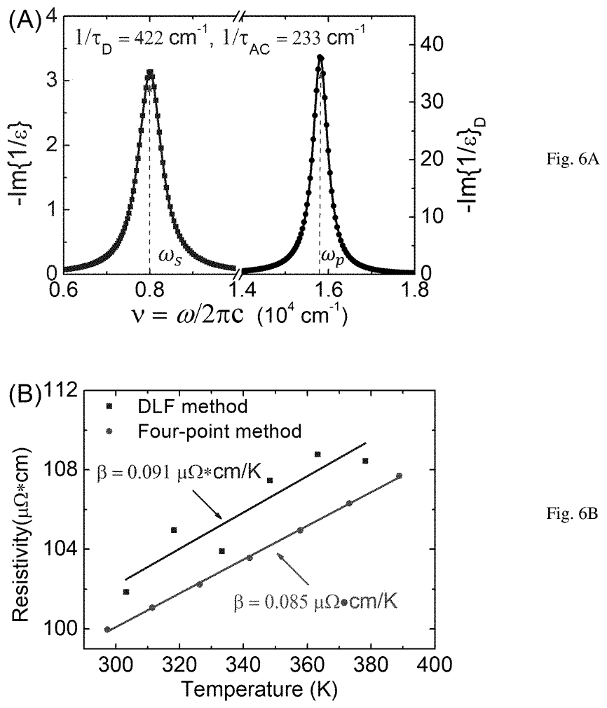

The application of DLF-BE analysis to non-metal was further explored. In order to test the validity of this method to conducting semiconductors, an 176 nm thick indium-tin oxide (ITO) film sample is measured by ellipsometry at 303 K. The resistivity ρₚ obtained by DLF-BE in FIG. 6A is 101.9 μft cm, matching well with the DC four-point probe measurement of 100.4 μΩ·cm at the temperature. This result proves that the method can be applied well in semiconducting materials with conduction electrons.

According to Matthiessen's rule, 1/τ_{D} is composed of two terms:

1/τ_{D} =¹/tₑ₋ᵢ +1/⁻cₑ₋ₚ(T). (A14)

Here 1/τₑ₋ᵢ represents the scattering rate of electron-impurity (extrinsic) and 1/⁻cₑ₋ₚ (T), the scattering rate of electron-phonon (intrinsic), which is temperature dependent.

To further separate the two terms, temperature dependent measurements of dielectric constants are required. Ellipsometry measurement is carried out on ITO film from 303 K to 378 K at 15K interval. The results of DLF-BE analysis are given in Table 2 (FIG. 7B). The sheet resistance is also measured from 297.3 K to 388.8 K at 15 K interval by four-point probe. FIG. 6B compares the resistivity of the ITO sample obtained with DLF-BE analysis of optical data with the four-point probe data at various temperatures. Using the relation

$${ρ}_{dc} = \frac{4 π}{{ω}_{p}^{2}} \frac{1}{{τ}_{D}} = {ρ}_{e - i} + β \cdot T ,$$

the value of resistivity originated from electron-impurity scattering is determined by non-geometry-sensitive optical method to be Σₑ₋ᵢ=74.8 μΩ·cm, nearly the same as the geometry-sensitive DC contact measurement value of 74.7 μΩ·cm. Meanwhile, the deviation of the temperature-dependence slope of the electron-phonon term obtained by the two methods agree well (less than 10%) considering four-point probe method is dependent on geometry factor with limited accuracy. The results seem to suggest that the method describe here is applicable to the electrical transport measurement of both metals and semiconductors with conduction electrons through impurity and optical doping at various temperatures, providing a potentially fast, non-destructive and micro-area detection method for semiconductor industry applications.

The above descriptions demonstrate that the large discrepancies in the electrical transport properties between Drude-Sommerfeld model and DC contact measurements in metallic elements is resolved by DLF-BE analysis. The bound electron contributions result in an extra damping effect of conduction electrons at plasma resonance and a shift of plasma resonance frequency. From physics point of view, the optical radiation should also interact with the background lattice, where the atoms are surrounded (or screened) by bound electrons to cause polarization (bound electron cloud deformation), which in turn affects the conduction electrons. The elastic deformation screens conduction electron charge, leading to a change in effective carrier density and a shift of the plasma resonance. The inelastic deformation causes additional scattering/loss in conduction electron movement and reduces quantum relaxation time.

The above descriptions show that by adopting the dielectric loss function analysis into the physics of plasma resonance, the reciprocal quantum relaxation time in DC field 1/τ_{D} and at non-zero frequency 1/τ_{AC} can be directly measured for the first time through damping effect of plasma resonance. The DLF-BE analysis results are well consistent with various experimental results and theoretical calculations. The results show that the bound electron inelastic scattering to conduction electrons is the dominating damping effect of quantum relaxation time at optical frequencies. Although the bound electron contributions to dielectric functions are known for a long time, its contribution to quantum relaxation time of conduction electrons has never been realized until now.

Details on calculations of ϵ^{B} (ω) and ωₚ using DFT.

The DFT calculations were carried out with the Perdew-Burke-Ernzerhof exchange- correlation functional with Vienna Ab initio Simulation Package (VASP). The plane-wave energy cutoff was set to 300-428 eV depending on the systems and the projector augmented-wave pseudopotentials were used. For the transition metals of Ni, Ag, and Au, the Hubbard U method was utilized with an effective U-J value of 3.5, 2.8, 3.2 eV, respectively. Monkhorst-Pack k-point grids were used for sampling the Brillouin zone with a spacing of −0.03 Å⁻¹. The imaginary dielectric function of bound electrons can be calculated using the following Fermi's golden rule under the dipole approximation, as shown in Equation (A15).

$${ɛ}_{i}^{B} ( ω ) = \frac{1}{4 {πɛ}_{0}} {( \frac{2 π e}{m ω} )}^{2} {\sum }_{k , c , v} {\vert 〈 {Ψ}_{k}^{c} \vert e \cdot p \vert {Ψ}_{k}^{v} 〉 \vert}^{2} δ ( {E}_{k}^{c} - {E}_{k}^{v} - ℏω ) \qquad ( A15 )$$

where e is the polarization vector of the incident electric field, p is the momentum operator, and c and v represent the conduction and valence bands, respectively. The real dielectric function of bound electrons ϵᵣ^{B}(ω) can then be obtained from ϵᵢ^{B} (ω) through the Kramers-Kronig relation. coₚ can be obtained through the direct-current electrical conductivity calculation using the

Boltzmann transport equation (Equation (A16)), as implemented in the BoltzTraP2 program.

$${ω}_{p}^{2} = 4 {πσ}_{dc} / {τ}_{dc} = \frac{{e}^{2}}{2 {π}^{2}} \int \int {\sum }_{n} \frac{\partial {E}_{n , k}}{\partial k} ⊗ \frac{\partial {E}_{n , k}}{\partial k} ( - \frac{\partial f ( E , T )}{\partial E} ) δ ( E - {E}_{n , k} ) dkdE \qquad ( A16 )$$

where E_{n,k} is the orbital energy calculated using VASP and f the Fermi-Dirac distribution. Then ω_{s-DFT} can be estimated by ωₛ=ωₚ/\vec{√1+_{ϵr}^{B}(ωₛ₋ₑₓₚ)}. Details on ITO measurements.

ITO films of nominal thickness of 180 nm were purchased from Hefei Kejing Material Technology Co., Ltd. prepared by magnetron sputtering. Spectra of the ellipsometric angles w (amplitude ratio) and A (phase shift difference) were acquired at various temperatures with a commercial spectroscopic ellipsometer (RC2, J. A. Woollam) operating in reflection mode in the 210-2500 nm wavelength range. Focusing probes were used to reduce the beam diameter to 500 μm at the sample surface. All the measurements were performed at the incidence angle of 70° . The complex dielectric function calculated from the w and A was achieved using CompleteEASE software, with surface roughness considered. The refractive index n and the extinction coefficient k of ITO parameterized at 632.8 nm at room temperature are 1.740 and 0.033, respectively. A standard heat stage (HTC-100) was used to control the temperature. Rate of temperature change was slow enough (0.5 K/minute) to ensure the cooling and heating data are consistent for more accurate temperature measurement.

### Transport Properties of Photo-Induced Carriers

The first embodiment described above shows that analysis of dielectric loss function near the plasma frequency of conducting materials can determine carriers' transport properties of conductors accurately. The second embodiment and its variations described below provide a method of accurately characterizing the intrinsic electrical properties of photo-induced carriers in the intrinsic WBGSs by similar optical method.

In the second embodiment, coherent or incoherent photons is used to elevate all the valence electrons into free electrons, and subsequently excite coherent plasma resonance of the saturated photo-induced electrons. Since carbon-based materials are the most widely used semiconductors in industrial application, this optical method was applied to two carbon polytypes (graphite and diamond) and two carbide WBGSs (SiC and B4C) as examples.

Meanwhile, the determination of their transport properties was also given in detail. This demonstrates the validity of the optical method by the plasma resonance of photo-induced electrons in identifying the intrinsic transport properties of WBGSs. It is notably that the fully excited photo-induced carriers have a larger scattering rate (low mobility). Hence, one possible solution is by decreasing the incident light intensity to lower down the plasma frequency of photo-induced carriers in intrinsic WBGSs, which would lead to a lower electron scattering rate (high mobility). Accordingly, some potential pathways of high-performance millimeter wave or quantum optical-electronic devices are described. The methods described here may also provide guidelines for seeking the new suitable WBGSs before long and difficult effort of solving the doping problems.

The dielectric loss function (DLF, the inverse of the dielectric function) describes the energy loss in the solid under electromagnetic field irradiation and is :

$$\frac{1}{ɛ ( ω )} = \frac{{ɛ}_{r} ( ω ) - i {ɛ}_{i} ( ω )}{{ɛ}_{r}^{2} ( ω ) + {ɛ}_{i}^{2} ( ω )} , \qquad ( B1 )$$

with ϵᵣ(ω)=ϵᵣ^{D}(ω)+ϵᵣ^{B}(ω) and ϵᵢ(107 )=ϵᵢ^{B} (ω) EB (co). Here ‘D’ and ‘13’ refer to free-electron effect and bound-electron effect, ‘r’ and ‘i’ represent the real and imaginary parts, respectively. Similar to the Drude model based on free electron gas, the plasma frequency of photo-excited intrinsic semiconductors ϵₚ =(nₚₑe²/ϵ₀m*)^{1/2}, where nₚₑ is the photo-excited electron charge density, ϵ₀ is the vacuum permittivity, e is the unit charge, and m* is effective mass. At the plasma frequency ωₚ, the dielectric constant for free electrons (the Drude term) ϵᵣ^{D} changes the sign. If only the interaction with free electrons ϵ^{D} (ω) is considered, the imaginary part of the dielectric loss function is:

$$- Im {\{ \frac{1}{ɛ ( ω )} \}}_{D} = \frac{{ω}_{p}^{2} {ωγ}_{D}}{{( {ω}^{2} - {ω}_{p}^{2} )}^{2} + {ω}^{2} {γ}_{D}^{2}} , \qquad ( B2 )$$

where γ_{D} is the frequency-independent DC electron scattering rate.

Considering the elastic deformation of bound electron charge cloud under an optical field, the resonance frequency shifts from ωₚ to the screened plasma frequency ωₛ, where the real part of total dielectric function ϵᵣ (ωₛ) equals to zero. The screened plasma frequency is written as:

ωₛ=(ωₚ²/ϵ_{c}(ωₛ)−γ_{D}²)^{1/2} (B3)

where the background dielectric polarizability ϵ_{c}(ωₛ) is given by ϵ_{c}(ωₛ)=1+ϵᵣ^{B}(ωₛ). And the imaginary part of total dielectric loss function is expressed as:

$$- Im ( \frac{1}{ɛ ( ω )} ) = \frac{\frac{{ω}_{p}^{2} {γ}_{D}}{ω ( {ω}^{2} + {γ}_{D}^{2} )} + {ɛ}_{i}^{B} ( ω )}{\begin{matrix}{( {ɛ}_{c} ( ω ) - \frac{{ω}_{p}^{2}}{{ω}^{2} + {γ}_{D}^{2}} )}^{2} + \\ {( \frac{{ω}_{p}^{2} {γ}_{D}}{ω ( {ω}^{2} + {γ}_{D}^{2} )} + {ɛ}_{i}^{B} ( ω ) )}^{2}\end{matrix}} . \qquad ( B 4 )$$

Based on Eq. (B3) and Eq. (B4), the resonant peak value of dielectric loss spectrum at coₛ becomes:

$$\begin{matrix}- Im \{ \frac{1}{ɛ ( {ω}_{s} )} \} = \frac{1}{{ɛ}_{i} ( {ω}_{s} )} \\ = \frac{{ω}_{s} / {ɛ}_{c} ( {ω}_{s} )}{{γ}_{D} + {ɛ}_{i}^{B} ( {ω}_{s} ) {ω}_{s} / {ɛ}_{c} ( {ω}_{s} )} \\ = \frac{{ω}_{s}}{{ɛ}_{c} ( {ω}_{s} ) {γ}_{O} ( {ω}_{s} )} .\end{matrix} \qquad ( B 5 )$$

Based on Eq. (B5), an equivalent optical electron scattering rate yₒ (co) may be obtained, which corresponds to the full width at half maximum (FWHM) of the resonant peak:

Yo(ws)=YD YAc(ws), (B6)

where y_{AC}(ωₛ) =EP (coₛ)coₛ/E_{c} is frequency-dependent and originated from the additional scattering by the bound electrons of intrinsic semiconductors due to inelastic polarization.

According to the second embodiment, coₛ, E_{c}(G0ₛ), and yₒ (coₛ) are first determined with the measured peak position, peak value and FWHM of the photo-induced plasma resonance in the total dielectric loss function. Through fitting the experimental data by considering the degree of asymmetry of the plasma peak and a tentative form of ϵᵢ^{B} (ω) around the plasma frequency, y_{D} can be derived based on Eq. (B5) and subsequently coₚ by Eq. (B3). And then the contribution of bound electrons can be eliminated based on the relation: E(GO) =ED (co) _{E}B (co) with an axis

$$( ω , - Im \{ \frac{1}{ɛ ( ω )} \} ) to ( {ω}^{′} , - Im {\{ \frac{1}{ɛ ( {ω}^{′} )} \}}_{D} ) ,$$

transformation from yielding the pure Drude term of the dielectric loss function. The resistivity and mobility at DC field can also be derived as pₚ =y_{D}/Eₒcoₚ², and pₚ =e Inm

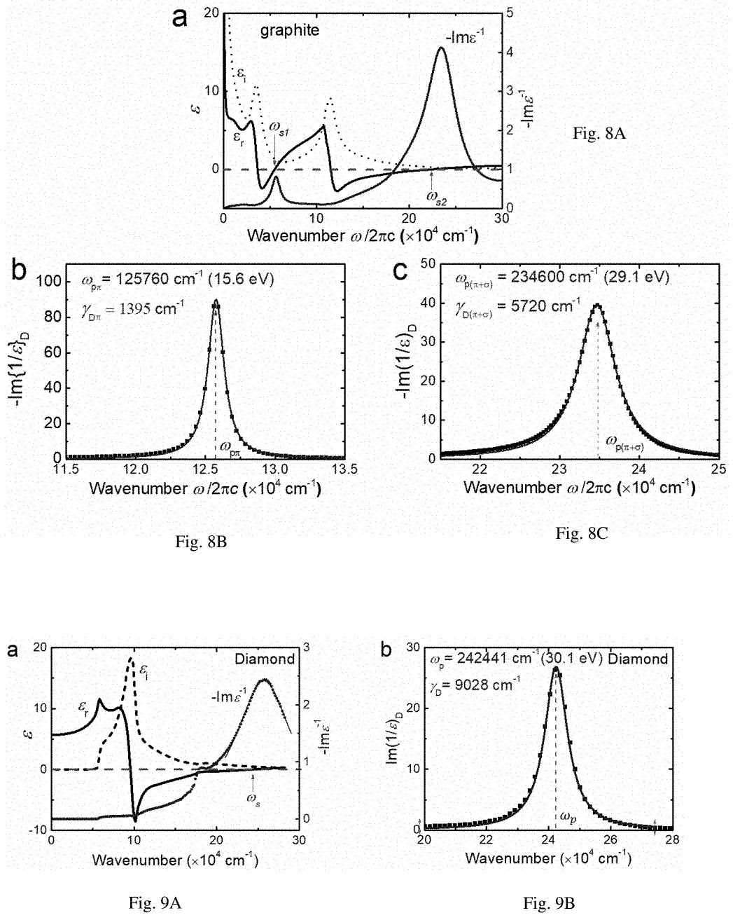

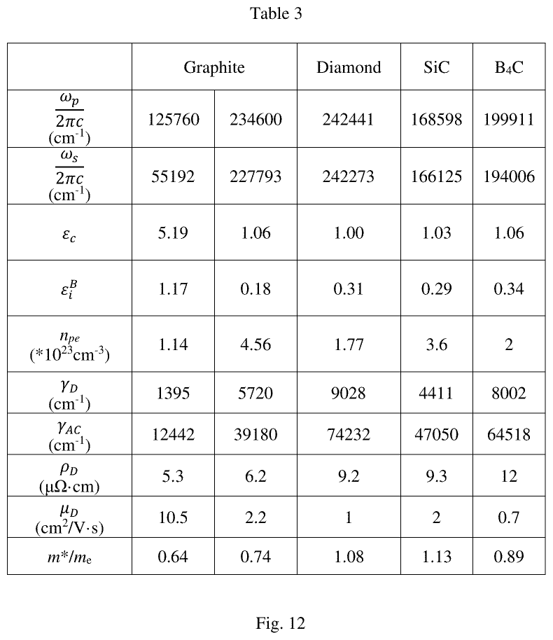

Examples of generating a coherent plasma resonance by photo-induced carriers in semimetals are described first. Taking graphite for instance, band structure of graphite has a unique formation of conducting band (7c orbital) and valence band (a orbital). It has been known that the frequency-dependent dielectric function E (co) and dielectric loss function ImE(co)⁻¹ can be derived from the in-plane refractive index of graphite given as shown in FIG. 8A. The imaginary dielectric function E₁ (dotted black line) shows a sharp absorption peak at 35000 cm⁻¹ (4.3 eV) corresponding to 7C electron excitations and a broader peak at around 114500 cm⁻¹ (14.2 eV) corresponding to a electron transitions, which can be accounted for by band structure calculations. There are two plasma resonant peaks appearing in the dielectric loss function ImE(co)⁻¹. Unlike the metals, the electrons in conducting band (7c orbital) of semimetal material graphite are not fully free carriers in the solids. Hence, the lower peak around coₛₜ =55192 cm⁻¹ (6.8 eV) is originating from optical collective excitations of 7C electrons, while the stronger one near coₛₜ =227793 cm⁻¹ (28.2 eV) is associated with plasma oscillations involving the combined it plus a electrons. This has also been known that the effective number of electrons per atom reaches gradually to one with increasing energy to 10 eV, and then to four above 25 eV. These two photo-induced plasma peaks in dielectric loss function provide an accessible platform to probe the transport properties of conduction bands in graphite. The analyses of DLF for it electrons and n+a electrons were shown in FIGS. 8B and 8C respectively, where the contribution of the bound electrons is removed, only leaving the DC term. The DC term is perfectly fitted by the Drude model, and the related fitting parameters were shown in Table 3 (FIG. 12).

Notations used in Table 3: coₚ/2n⁻c: the bare plasma frequency of photo-induced carriers; ωₛ/2πc: the screened plasma frequency of photo-induced carriers; E_{c}: the background dielectric polarizability at ωₛ; ϵᵢ^{B}: the imaginary part of dielectric function contributed from bound electrons at ωₛ ; n_{pc}: the saturated photo-induced carrier density; γ_{D}, γ_{AC}, and rn*/rne: the DC electron scattering rate, the AC electron scattering rate, the resistivity and mobility at DC field, the effective mass for the saturated-excited carriers, respectively. For the collective excitations of it electrons in FIG. 8B, the screened and bare plasma frequency co and coₚ, are 55192 cm⁻¹ and 125760 cm⁻¹ (6.8 eV and 15.6 eV) respectively. As is well known, the atomic density of graphite is 1.14*10²³ cm ⁻³ and each atom has one it electron. Then the carrier density for the photo-induced it electrons should be 1.14×10²³ cm⁻³, as the 7 band is essentially exhausted in this energy range. Furthermore, the effective mass of it electrons (conduction band) can be accurately determined to be 0.64rnₑ (mₑ is free-electron mass) based on the relation: ωₚ=(nₚₑe²/ϵ₀m*)^{1/2}. Notably, the ω_{pπ}(15.6 eV) by this method is relatively larger than the value (12.5 eV) previously believed. It is mainly due to the fact that the free-electron mass mₑ is treated as effective mass m* in the calculative process. The electron scattering rate of conduction it electrons is γ_{Dπ}=1395 cm⁻¹ at zero frequency, which is one order of magnitude less than the AC term γ_{ACπ}=12442 cm⁻¹, indicating that inelastic polarization of bound electrons dominates the scattering mechanism at optical frequencies. Hence, the DC resistivity and mobility of conduction it electrons can be identified to be p_{dπ}=γ_{Dπ}/ϵ₀ω_{pπ}²=5.3 μΩ·cm, and μ_{Dπ}=e/γ_{Dπ}m8=10.5 cm²/V·s.

Further increasing the energy of incident photons can excite all the a-electrons of graphite into the collective plasma resonance at the screened plasma frequency ω_{s(π+σ)}=227793 cm⁻¹ (28.2 eV), very close to the bare plasma frequency of ω_{p(π+σ)}=eV) in FIG. 8C. The carrier density of photo-induced it plus a electrons is 4.56*10²³ cm⁻³ for four excited valence electrons per atom, and the effective mass of π plus a electrons is 0.74 mₑ. However, the high carrier density results in a much higher electron scattering rate yₚₒᵣ₊,) =5720 cm⁻¹ and γ_{AC(π+σ)}=39180 cm⁻¹.

Such a high electron scattering rate would result in the carriers' mean free path approaching a value on the order of lattice constant, indicating that photo-induced charge carriers are essentially localized around the atoms. Correspondingly, the DC resistivity p_{D(πσ)} and mobility μ_{D(π+σ)} for photo-induced it plus a electrons are 6.2 μΩ·cm and 2.2 cm²/V·s. It is worth noting that the photo-induced bare plasma frequency ω_{p(π+σ)} (227793 cm⁻¹) for π plus ν electrons is very close to its screened plasma frequency ω_{s(πσ) (}234600 cm⁻¹), while the former ω_{pπ}(125760 cm⁻¹) for a electrons is nearly two times of the latter ω_{sπ}(55192 cm⁻¹) for a electrons. This suggests that when the electrons in the valence band was fully excited, the elastic polarization effect of bound electrons has feeble influence on the screening of charge carriers. However, the AC term of electron scattering rate γ_{AC(π+σ)} remains much larger than the DC term γ_{D(π+σ)}, which indicates that the inelastic scattering between bound electrons and conduction electrons still plays a dominant role even though the valence band is essentially empty. This is also confirmed by the results of other carbide semiconductors in Table 3.

Diamond, as the allotrope of graphite, was also investigated by this DLF method to make a contrast. The dielectric function ϵ(ω) and dielectric loss function −1mϵ(ω)⁻¹ of diamond were plotted in FIG. 9A, based on the previously known reflectance measurements. As shown in Table 3, the screened plasma frequency of diamond ωₛ=242273 cm⁻¹ (30.0 eV) is nearly the same as the bare plasma frequency ωₚ=242441 cm⁻¹ (30.1 eV), being consistent with the previously known result of 250046 cm⁻¹ (31.0 eV). As the atom density of diamond is 1.77*10²³ cm⁻³, the photo-induced carrier density for the four valence electrons should be 7.08*10²³ cm ³, which gives an effective mass of 1.08mₑ. In FIG. 9B, the DC term of DLF of diamond was fitted by the Drude model, which yielded the DC electron scattering rate y_{D} of the excited valence electrons is 9028 cm⁻¹, and the resistivity and mobility were then calculated to be 9.2 μΩ·cm and 1.0 cm²/V s, respectively.

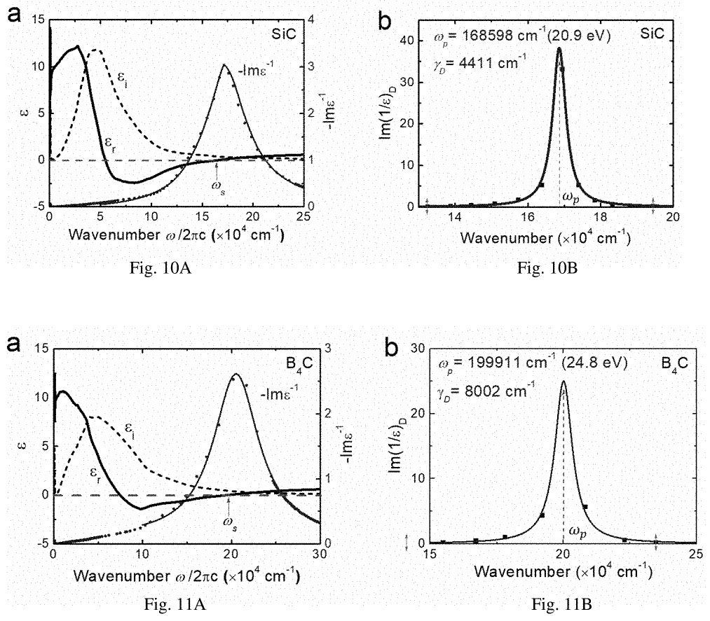

This DLF method was further applied to the carbide wide-bandgap semiconductors, including diamond, SiC, and B₄C, as shown in FIGS. 10A-B and 11A-B. In FIG. 10A, the dielectric function and dielectric loss function of SiC in the wavenumber range from 0 to 2.5*10⁵ cm⁻¹ (31.0 eV) were obtained based on the known optical constant of SiC film, with the screened plasma frequency ωₛ=166125 cm⁻¹ (20.6 eV). Through the analyses by the DLF method as shown in FIG. 10B, the bare plasma frequency ωₚ168598 cm⁻¹(21.0 eV) and the DC electron scattering rate γ_{D}=4411 cm⁻¹ were identified. Given that the molecular density of SiC is 2.98 g/cm³, the molecular density is 4.5*10²² cm⁻³. According to the theoretically calculated density of states, the electrons in the C 2s, 2p and Si 3s, 3p states are fully stimulated into free electrons in the energy range above 15 eV. Hence the photo-induced carrier density should be 3.6*10²³ cm⁻³, which suggests an effective mass of 1.13 mₑ, the resistivity of 9.3 μΩ·cm and the mobility of 2.0 cm²/V·s, respectively.

For B₄C, previously known optical data were used to plot the dielectric function and dielectric loss function in the wavenumber range from 0 to 3.0*10⁵ cm⁻¹ (37.2 eV), as presented in FIG. 11A. The real part of dielectric function ϵₜ (ω) of B₄C changes the sign at the screened plasma frequency ωₛ=194006 cm⁻¹ (24.1 eV), corresponding to the plasma resonance of photo-induced carriers. Accordingly, its bare plasma frequency ωₚ is 199911 cm⁻¹ (24.8 eV), with the DC electron scattering rate of 8002 cm⁻¹ in FIG. 11B. The molecular density of B4C is 2.28 g/cm³, corresponding to the molecular density of 2.5*10²² cm−3, which gives the photo-induced carrier density is 2.0*10²³ cm⁻³ in the high energy range. The effective mass, resistivity and mobility of B4C were further calculated to be 0.89 mₑ, 12.0 μΩ·cm, and 0.7 cm²/V·s, respectively.

As exhibited in Table 3, the electron scattering rates y_{D} and _{YAC} of all the above 4 materials are considerably large when all the valence electrons are excited into the conduction bands. This would lead to a quite small coherent time or an ultra-low mobility, which is not favorable for the recent quantum electronic devices. However, in practical applications, the radiation intensity of optical field may be tuned to lower down the photo-induced carrier density and force the photo-induced plasma frequency into a lower frequency, e.g., microwaves or terahertz. The lowered photo-induced carrier density may result in a much lower y_{D}, suggested by the phenomenon that most 2D materials have large mobilities (larger than 10⁴ cm²/V·s) with low carrier density. Simultaneously, searching a proper frequency with much lower value of ϵᵢ^{B} may greatly decrease the γ_{AC}. Thus, a much lower electron scattering rate (or higher mobility) may be obtained in the photo-doping WBGSs, which would have a long mean free path to excess the recombination process, for the requirement of high performance mm wave or quantum devices.

This method may be directly utilized in the intrinsic WBGSs, avoiding the disadvantages of defects due to impurity doping. One potential utilization for integrated circuits is fabricating two-dimensional metasurfaces upon the WBGSs nanostructures to provide excitation light photons for each WB GS nanodevices, as the pattern in recent metalens-array based quantum source. Another possible usage is to construct the planar heterojunction architecture of WBGSs and electron/hole transporting layers, like the solar cells based on organic-inorganic perovskites. In conclusion, the feasibility of DLF method has been demonstrated in the investigations of photo-induced conduction electrons in WBGS materials, including graphite, diamond, SiC and B₄C. Some key parameters of the electrical properties of their conduction band, such as carrier density, effective mass, the DC electron scattering rate, resistivity and mobility, were identified. Notably, although the elastic polarization effect of bound electrons has negligible influence on the screening of photo-induced charge carriers, the inelastic scattering between bound electrons and conduction electrons dominates the electron scattering rate in this frequency range. One solution is by tuning the photon intensity to increase the mobility for the demand of practical application. This embodiments provide methods in the characterization of electrical properties of conduction band in WBGSs, which should have great impact on the development of advanced intrinsic WBGS-based devices.

### Summary of Measurement Methods

FIG. 13 schematically illustrates a method of direct measurement of frequency-dependent quantum relaxation time of electrons in a material sample according to the first embodiment of the present invention. In step S11, the optical data of the sample is measured to obtain the imaginary part of the dielectric loss function as a function of frequency,

$$- Im ( \frac{1}{ɛ ( ω )} ) .$$

This step includes two sub-steps. In sub-step S11-1, the spectra (functions of frequency) of the ellipsometric angles ψ (amplitude ratio) and A (phase shift difference) of the sample is measured using a spectroscopic ellipsometer (which is commercially available). In sub-step S112, the complex dielectric function is calculated from the measured ellipsometric angles ψ and Δ values, and the complex dielectric loss function, which is the inverse of the complex dielectric function, is then calculated.

In step S12, the imaginary part of the dielectric loss function is analyzed to obtain the quantum relaxation time, including the DC term τ_{D} and the AC term at the screened plasma frequency τ_{AC} (ωₛ) More specifically, this step includes two sub-steps. In sub-step S12-1, the peak (the plasma resonance peak) of the imaginary part of the dielectric loss function curve is identified and analyzed to obtain ωₛ, ϵ_{c}(ωₛ), τ₀ (ωₛ) values from the peak position, peak height, and peak width (FWHM) values of the peak, respectively. In sub-step S12-2, the imaginary part of the dielectric loss function is curve-fitted to Equations (All) by considering the asymmetry of the peak, to obtain ϵᵢ^{B} (ω) around the plasma frequency and τ_{D}; and then ωₚ is obtained using

Equation (A9) (the resonance frequency shift relationship). τ_{AC} (ωₛ) is also calculated from EP (co). For the curve fitting, within the narrow vicinity of plasma resonance, ϵᵢ^{B} (ω) can be approximated as either a constant or a simple function, such as a linear function.

For some materials, the quantum relaxation time is temperature dependent. Thus, the spectra are measured at multiple temperatures, by using a heat stage (commercially available) to control the sample temperature, and the data measured at each temperature is analyzed.

FIG. 14 schematically illustrates a method of direct measurement of transport properties of photo-induced carriers in a material according to the second embodiment of the present invention. In step S21, the sample is irradiated with a coherent or incoherent light, so as to elevate all the valence electrons into free electrons, and the optical data of the sample is measured while the sample is irradiated. The imaginary part of the dielectric loss function as a

$$- Im ( \frac{1}{ɛ ( ω )} ) ,$$

function of frequency, is obtained from the measurement data in a way similar to step S11 of the first embodiment.

In step S22, one or two or more peaks in the imaginary part of the dielectric loss function are identified, and are separately analyzed to obtain the electron scattering rate for corresponding groups of electrons from two or more bands. For each peak, the analysis includes two sub-steps which are similar to the two sub-steps of step S12 of the first embodiment. In sub-step S22-1, the peak of the imaginary part of the dielectric loss function curve is analyzed to obtain ωₛ, ω_{c}(ωₛ) and γₒ (ωₛ) values at plasma frequency, from the peak position, peak height, and peak width (FWHM) values of the photo-induced plasma resonance peak, respectively. In sub-step S22-2, the imaginary part of the dielectric loss function curve-fitted to Equations (B4) by considering the degree of asymmetry of the plasma peak to obtain ϵᵢ^{B} (ω) around the plasma frequency, then to obtain γ_{D} based on Eq. (B5), and subsequently to obtain ωₚ based on Eq. (B3). This analysis gives the DC term of the electron scattering rate γ_{D} and the AC term of the electron scattering rate at the screened plasma frequency γ_{AC} (ωₛ).

In step S23, other transport properties, such as the resistivity and mobility at DC field, are derived from the electron scattering rate.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for direct measurement of quantum relaxation time of electrons in a material sample, comprising:
measuring optical data of the sample to obtain an imaginary part of a dielectric loss function as a function of frequency ω,
$$- Im ( \frac{1}{ɛ ( ω )} ) ;$$
and
analyzing the imaginary part of the dielectric loss function to obtain a frequency-independent quantum relaxation time τ_{D} of the sample and a frequency-dependent quantum relaxation time of the sample at a screened plasma frequency ωₛ , τ_{AC} (ωₛ)

2. The method of claim 1, wherein the measuring step includes:
using a spectroscopic ellipsometer, measuring spectra of ellipsometric angles w (amplitude ratio) and Δ (phase shift difference) of the sample; and
calculating a complex dielectric function ϵ(ω) of the sample from the measured ellipsometric angles ψ and Δ, and calculating the complex dielectric loss function of the sample as an inverse of the complex dielectric function.

3. The method of claim 1, wherein the analyzing step includes:
identifying a peak in the imaginary part of the dielectric loss function; and
obtaining the screened plasma frequency ωₛ, a background dielectric polarizability at the screened plasma frequency ϵ_{c}(ωₛ), and an equivalent optical quantum relaxation time at the screened plasma frequency τₒ (ωₛ) from a peak position, a peak height, and a peak width of the peak, respectively, where the peak position equals the screened plasma frequency ωₛ, the peak height equals
$$\frac{{ω}_{s}}{{ɛ}_{c} ( {ω}_{s} )} {τ}_{o} ( {ω}_{s} ) ,$$
and a full width at half maximum of the peak equals 1/τ₀ (ωₛ).

4. The method of claim 3, wherein the analyzing step further includes:
curve-fitting the imaginary part of the dielectric loss function based on an asymmetry of the peak using an equation:
$$- Im ( \frac{1}{ɛ ( ω )} ) = \frac{\frac{{ω}_{p}^{2}}{{ωτ}_{D} ( {ω}^{2} + {τ}_{D}^{- 2} )} + {ɛ}_{i}^{B} ( ω )}{\begin{matrix}{( 1 - \frac{{ω}_{p}^{2}}{{ω}^{2} + {τ}_{D}^{- 2}} + {ɛ}_{r}^{B} ( ω ) )}^{2} + \\ {( \frac{{ω}_{p}^{2}}{{ωτ}_{D} ( {ω}^{2} + {τ}_{D}^{- 2} )} + {ɛ}_{i}^{B} ( ω ) )}^{2}\end{matrix}} ,$$
to obtain ϵᵢ^{B} (ω) in a vicinity of the screened plasma frequency, where coₚ is a plasma frequency, and ϵᵣ^{B (ω) and ϵ}ᵢ^{B} (ω) are a real part and an imaginary part, respectively, of a bound electron term ϵ^{B} (ω) of the complex dielectric function which represents elastic and inelastic deformation of bound electron polarization effect;
calculating τ_{D} based on ϵᵢ^{B}(ω), using equation:
$$\begin{matrix}- Im \{ \frac{1}{ɛ ( {ω}_{s} )} \} = \frac{1}{{ɛ}_{i} ( {ω}_{s} )} \\ = \frac{{ω}_{s} / {ɛ}_{c} ( {ω}_{s} )}{1 / {τ}_{D} + {ɛ}_{i}^{B} ( {ω}_{s} ) {ω}_{s} / {ɛ}_{c} ( {ω}_{s} )} ;\end{matrix}$$
calculating τ_{AC}(ωₛ) based on ϵᵢ^{B}(ω), using equation:
1/τ_{AC}(ωₛ)=ϵᵢ^{B}(ωₛϵ_{c} (ωₛ);
calculating ωₚ based on ϵ_{c}(ωₛ) and τ_{D}, using an equation which represents a resonance frequency shift:
$${ω}_{s}^{2} = \frac{{ω}_{p}^{2}}{{ɛ}_{c} ( {ω}_{s} )} - 1 / {τ}_{D}^{2} .$$

5. The method of claim 4, wherein in the curve-fitting step, ϵᵢ^{B} (ω) is approximated as either a constant or a linear function within the vicinity of the screened plasma frequency.

6. The method of claim 1, wherein the sample is a metal material.

7. The method of claim 1, wherein the sample is a conducting semiconductor.

8. The method of claim 7, wherein the quantum relaxation time is temperature dependent, wherein the measuring step includes:
controlling a temperature of the sample using a heat stage; and
measuring the optical data of the sample at a plurality of temperatures, and
wherein the analyzing step is performed for the optical data measured at each of the plurality of temperatures.

9. A method for direct measurement of transport properties of photo-induced carriers in a material sample, comprising:
irradiating the sample with a coherent or incoherent light to elevate all valence electrons into free electrons;
while irradiating the sample, measuring optical data of the sample to obtain an imaginary part of a dielectric loss function as a function of frequency ω,
$$- Im ( \frac{1}{ɛ ( ω )} ) ;$$
and
analyzing the imaginary part of the dielectric loss function to obtain a frequency-independent DC electron scattering rate γ_{D} and a frequency-dependent electron scattering rate at a screened plasma frequency ωₛ, Y_{Ac} (ωₛ)

10. The method of claim 9, wherein the measuring step includes:
using a spectroscopic ellipsometer, measuring spectra of ellipsometric angles w (amplitude ratio) and Δ (phase shift difference) of the sample; and
calculating a complex dielectric function ϵ(ω) of the sample from the measured ellipsometric angles ψ and Δ, and calculating the complex dielectric loss function of the sample as an inverse of the complex dielectric function.

11. The method of claim 9, wherein the analyzing step includes:
identifying a peak of the imaginary part of the dielectric loss function; and
obtaining the screened plasma frequency ωₛ, a background dielectric polarizability at the screened plasma frequency ϵ_{c}(ωₛ), and an equivalent optical electron scattering rate at the screened plasma frequency γₒ (ωₛ) from a peak position, a peak height, and a peak width of the peak, respectively, wherein the peak position equals the screened plasma frequency ωₛ, the peak height equals
$$\frac{{ω}_{s}}{{ɛ}_{c} ( {ω}_{s} ) {γ}_{O} ( {ω}_{s} )} ,$$
and a full width at halt maximum of the peak equals γ₀ (ωₛ).

12. The method of claim 11, wherein the analyzing step further includes:
curve-fitting the imaginary part of the dielectric loss function based on an asymmetry of the peak, using an equation:
$$- Im ( \frac{1}{ɛ ( ω )} ) = \frac{\frac{{ω}_{p}^{2} {γ}_{D}}{ω ( {ω}^{2} + {γ}_{D}^{2} )} + {ɛ}_{i}^{B} ( ω )}{\begin{matrix}{( {ɛ}_{c} ( ω ) - \frac{{ω}_{p}^{2}}{{ω}^{2} + {γ}_{D}^{2}} )}^{2} + \\ {( \frac{{ω}_{p}^{2} {γ}_{D}}{ω ( {ω}^{2} + {γ}_{D}^{2} )} + {ɛ}_{i}^{B} ( ω ) )}^{2}\end{matrix}}$$
to obtain ϵᵢ^{B} (ω) in a vicinity of the screened plasma frequency, where ωₚ is a plasma frequency, ϵ_{c}(ω)=1+ϵᵣ^{B}(ω), and ϵ_{τ}^{B}(ω) and ϵᵢ^{B}(ω) are a real part and an imaginary part, respectively, of a bound electron term ϵ^{B} (ω) of the complex dielectric function which represents elastic and inelastic deformation of bound electron polarization effect;
calculating Y_{D} based on ϵᵢ^{B}(ω), using equation:
$$\begin{matrix}- Im \{ \frac{1}{ɛ ( {ω}_{s} )} \} = \frac{1}{{ɛ}_{i} ( {ω}_{s} )} \\ = \frac{{ω}_{s} / {ɛ}_{c} ( {ω}_{s} )}{{γ}_{D} + {ɛ}_{i}^{B} ( {ω}_{s} ) {ω}_{s} / {ɛ}_{c} ( {ω}_{s} )} \\ = \frac{{ω}_{s}}{{ɛ}_{c} ( {ω}_{s} ) {γ}_{O} ( {ω}_{s} )} ;\end{matrix}$$
calculating y_{AC} (ωₛ) based on ϵᵢ^{B} (ω), using equation:
Y_{AC}(ωₛ)=ϵᵢ^{B}(ωₛ)ωₛ/ϵ_{c}; and
calculating coₚ based on £_{c}(coₛ) and _{YD}, using an equation which represents a resonance frequency shift:
$${ω}_{s} = {( {ω}_{p}^{2} / {ɛ}_{c} ( {ω}_{s} ) - {γ}_{D}^{2} )}^{1 / 2} .$$

13. The method of claim 12, wherein in the curve-fitting step, ϵᵢ^{B} (ω) is approximated as either a constant or a linear function within the vicinity of the screened plasma frequency.

14. The method of claim 12, wherein the sample is an intrinsic wide-bandgap semiconductor material, wherein the analyzing step further includes identifying multiple peaks in the imaginary part of the dielectric loss function, and wherein the obtaining step and the curve-fitting step are performed for each of the plurality of identified peaks.

15. The method of claim 9, further comprising:
calculating a resistivity of the sample pₚ =y_{D}lEₒcoₚ²; and
calculating a mobility at DC field of the sample as p._{D} =elyₚm*, where m* is an effective mass of the electrons.
